(19) United States
(12) Patent Application Publication
(10) Pub. No.: US 2015/0254012 A1
(43) Pub. Date: Sep. 10, 2015

(54) Data Compression Device

(71) Applicant: Hangzhou Dianzi University, Hangzhou City (CN)

(72) Inventors: Lingyan Fan, Hangzhou City (CN); Shi Wang, Hangzhou City (CN); Chris Tsu, Saratoga, CA (US)

(21) Appl. No.: 14/552,395

(22) Filed: Nov. 24, 2014

Related U.S. Application Data
(63) Continuation-in-part of application No. 14/199,987, filed on Mar. 6, 2014.

(51) Int. Cl. G06F 3/06; G06F 13/42

(52) U.S. Cl. CPC G06F 3/0619; G06F 3/0688; G06F 3/0655; G06F 13/4221

(57) ABSTRACT

A card reader system includes a card reader controller engine in communication with a Peripheral Component Interconnect Express (PCIe) host and one or more Serial Advanced Technology Attachment (SATA) hard disk drives (HDDs). The card reader controller engine includes a PCIe controller responsive to information from a PCIe host, an engine coupled to the PCIe controller that compresses the information before the information is stored in the SATA HDDs. The card reader controller engine further includes SATA hosts coupled to the engine and responsive to the compressed information for storage in and retrieval from the SATA HDDs.

### CROSS REFERENCE TO RELATED APPLICATIONS

This application is a continuation-in-part of U.S. patent application Ser. No. 14/199,987, filed on Mar. 6, 2014, by Fan et al., and entitled “Card Reader Controller with Compression Engine”.

Various embodiment of the invention relate generally to memory cards and particularly to memory card readers.

### BACKGROUND

Memory cards offer portability for transferring and/or maintaining large amounts of data in various forms, and are therefore widely employed. Examples of information stored in memory cards are video, pictures, data files, among a host of other types of information.

As memory has dropped in price and size, applications employing memory, such as memory card readers, have increased in popularity. A memory card today has a memory capacity orders of magnitude greater than those of, for example, five years ago and costs less than an equivalent memory card of back then if it would have been possible to make such memory cards. Memory cards are expected to continue to enjoy such popularity in the foreseen in the future.

Security is a near-must for the protection of information to guard against, or at least reduce the risk of, information theft. Unfortunately, as is well known, identity theft has been a major concern with personal and sensitive information being at risk. Portability of sensitive information, in a memory card, at times presents catastrophic risks.

Further, the transfer of information from a memory card to a host machine, for example from a portable memory drive to a personal computer (PC), is currently time-consuming. At a minimum, time consumption inconveniences users of memory cards particularly in today's fast-moving world where time is too high of an asset to spare. Moreover, performance of the memory card is hindered by current controllers utilized to direct the transfer of previously-stored information between a memory card and a host.

Accordingly, there is a need for card readers with higher performance and security.

### SUMMARY

Briefly, a card reader system includes a card reader controller engine in communication with a Peripheral Component Interconnect Express (PCIe) host and one or more Serial Advanced Technology Attachment (SATA) hard disk drives (HDDs). The card reader controller engine includes a PCIe controller responsive to information from a PCIe host, an engine coupled to the PCIe controller that compresses the information before the information is stored in the SATA HDDs. The card reader controller engine further includes SATA hosts coupled to the engine and responsive to the compressed information for storage in and retrieval from the SATA HDDs.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a card reader controller engine, in accordance with an embodiment of the invention.

FIG. 2 shows a card reader system, in accordance with an embodiment of the invention.

FIG. 3 shows a card reader system, in accordance with another embodiment of the invention.

FIG. 4 shows a card reader system, in accordance with yet another embodiment of the invention.

FIG. 5 shows a card reader system, in accordance with still another embodiment of the invention.

### DETAILED DESCRIPTION OF EMBODIMENTS

Particular embodiments and methods of the invention disclose a storage device having a disk controller and a non-volatile memory coupled to the disk controller and operable to save one or more passwords. The storage device further includes a media with more than one partition, the disk controller making each partition to be accessible to one or more users based on the saved one or more passwords.

The following description describes a card reader controller. The card reader employs one or more data compression/decompression engines causing improved performance and greater security, as discussed below.

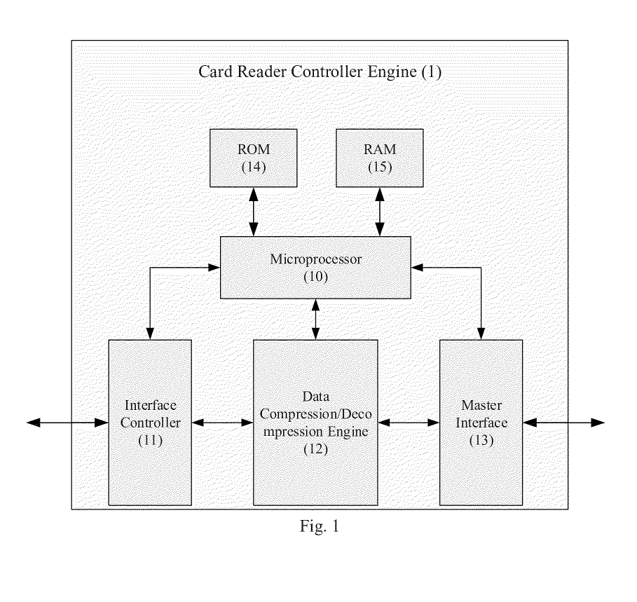

Referring now to FIG. 1, a card reader controller engine 1 is shown to include a microprocessor 10, an interface controller 11, a data compression/decompression engine 12, a master interface 13, a read-only-memory (ROM), and a random access memory (RAM), in accordance with an embodiment of the invention.

The microprocessor 10 is shown coupled to the ROM 14, the RAM 15, the interface controller 11, the data compression/decompression engine 12, and the master interface 13. As such, the microprocessor 10 controls the remaining blocks shown in the card read controller engine 1. The interface controller 11 is typically in communication with a host (not shown). Information, such as data, is transferred between the card reader controller engine 1 and the host through the interface controller 11 and under the direction of the microprocessor 10.

The master interface 13 is typically in communication with storage devices (not shown), such as memory cards. Information, such as data, is transferred between the card reader controller engine 1 and storage device(s) through the master interface 13 and under the direction of the microprocessor 10.

The data compression/decompression engine 12, as its name suggests, decompresses information received by the card reader engine 1 from a host, through the interface controller 11, and information received by the card reader engine 1 from storage device(s), through the master interface 13. The engine 12 similarly compresses information that is to be sent from the card reader engine 1 to storage device(s) through the interface controller 11, under the direction of the microprocessor 10. Compression and decompression allow for smaller-sized files and therefor require less storage space.

Further, the engine 12 compresses information received by the card reader controller engine 1 from storage device(s) through the master interface 13 and under the direction of the microprocessor. Accordingly, the data compression/decompression engine 12 is coupled to the interface controller 11 and the master interface 13.

In embodiments of the invention, the host is compliant with, without limitation, Universal Serial Bus (USB), Serial ATA (SATA) or Peripheral Component Interconnect Express (PCIe). In an embodiment of the invention, the engine 1 resides externally to the host.

The ROM 14 and the RAM 15 are both shown coupled to the microprocessor 10. The ROM 14 is typically used to maintain the program (software/firmware) executed by the microprocessor 10 and the RAM 15 is typically used to maintain data and/or program employed by the microprocessor. The microprocessor 10 operates by executing code (also referred to herein as “program”) that resides in the ROM 14 and/or the RAM 15.

The card reader controller 1 is physically apart of a single integrated circuit (IC), in an embodiment of the invention. In another embodiment of the invention, it is a part of multiple ICs and/or printed circuit boards (PCBs). In yet another embodiment of the invention, the card reader controller 1 resides on a single PCB. In still other embodiments of the invention, some or all portions of the card reader controller 1, shown in FIG. 1, are implemented in software and/or firmware.

In operation, the card reader controller 1 (also referred to herein as “memory card reader”) receives information through the interface controller 11 and under the direction of the microprocessor 10. The data compression/decompression engine 12 decompresses the received information to restore the received information to its raw state prior to having been compressed.

The decompressed information is then sent to the master interface 13, under the direction of the microprocessor 10, to a storage device, such as but not limited to, a memory card. As earlier noted, the information transmitted from the card controller engine 1 is first compressed prior to being sent out.

Information is received either through the interface controller 11 or the master interface 13 and, under the direction of the microprocessor 10, it is sent to the information compression/decompression engine 12, which compresses the information and sends the compressed information to either the interface controller 11 or the master interface 13 depending on the direction of information flow.

The data compression/decompression engine 12 may use one of many known algorithms to compress/decompress information. Without limitation, examples of compression/decompression algorithms are: Lempel-Ziv-Renau (LZR) and Lempel-Ziv-Welch (LZW).

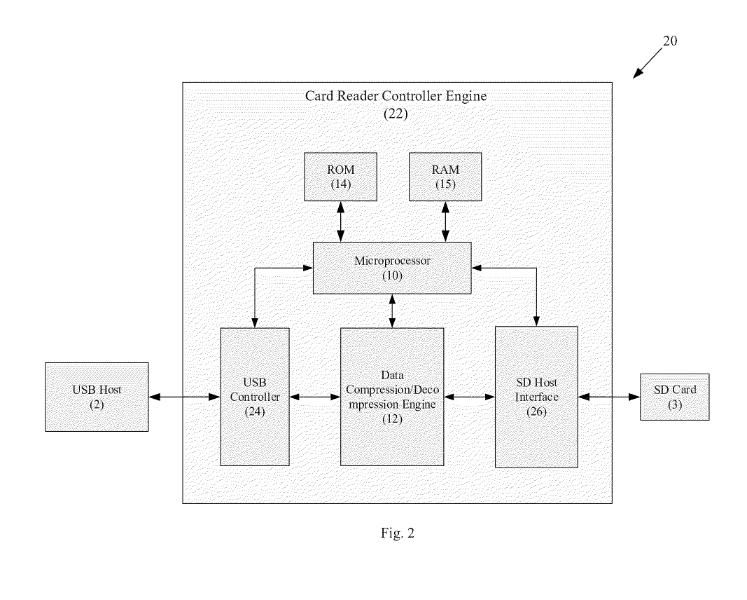

FIG. 2 shows a card reader system 20, in accordance with an embodiment of the invention. The system 20 is shown to include the card reader controller engine 22, the Universal Serial Bus (US) host 2, and the Storage Device (SD) card 3. The engine 22 is shown coupled to the USB host 2 and the SD card 3. The engine 22 is analogous to the engine 1 of the embodiment of FIG. 1 except that the interface controller 11 of the engine 1 is replaced with the USB controller 24 in the engine 22 and the master interface 13 of the engine 1 is replaced with the SD host interface 26 in the engine 22.

In FIG. 2, the USB controller 24 is shown coupled to the USB host 2 and the SD host interface 26 is shown coupled to the SD card 3. In this respect, the engine 22, through the USB controller 24, transmits and receives information to and from the USB host 2 and, through the SD host interface, the engine 22 transmits and receives information to and from the SD card 3. The USB host 2 complies with the industry-adopted USB Standard and the SD card 3 complies with the industry-adopted SD Standard.

In operation, analogous to the engine 1 of the embodiment of FIG. 1, information from the USB controller 24 is transmitted to the data compression/decompression engine 12. The engine 12 decompresses the information it receives and transmits the decompressed information to the SD host interface 26 for transmission to the SD card 3 where it is saved. Similarly, information from the SD card 3 is transmitted to the SD host interface 26 and then sent to the data compression/decompression engine 12 where it is decompressed before it is sent to the USB controller 24 to be transmitted to the USB host 2. When information, received from the SD card 3 is not compressed, upon the SD host interface 26 sending the information to the data compression/decompression engine 12, it is compressed and then sent to the USB host 2, through the USB controller 24. Similarly, when uncompressed (raw) information is received from the USB host 2, it is compressed by the data compression/decompression engine 12 before it is passed on the SD card 3.

The SD card 3 is a portable memory card used to save information and/or transfer information from one device to another. For example, the SD card 3 may maintain backed-up information that is to be retrieved due to a malfunction and therefore corruption of current information. In this respect, the information is first saved in the SD card 3 and when the SD card 3 is connected to the engine 22, the backed-up or saved information is then transmitted, through the SD host interface 26, to the data compression/decompression engine 12 assuming it is compressed information. The data compression/decompression engine 12 decompresses the information and transmits the decompressed information to the USB controller 24. The USB controller 24 ultimately transmits the decompressed information to the USB host 2, which can restore the information.

As an example of the improvement of the system of FIG. 2 and those of other embodiments shown and discussed herein, assuming the data transfer rate of SATA to be 250 Mega Bytes (MB)/second (s) and the transfer rate of SD card to be 50 MB/s, with the use of two SD cards connected to the card reader controller engine, the effective transfer rate will be 100 MB/s when no data compression is performed. Assuming further that the average data compression ratio is 0.5, then the effective data transfer rate is 100 MB/s 0.5=200 MB/s (or doubled) when data compression is performed, therefore, performance is greatly improved by the card reader controller engines of the various embodiments of the invention.

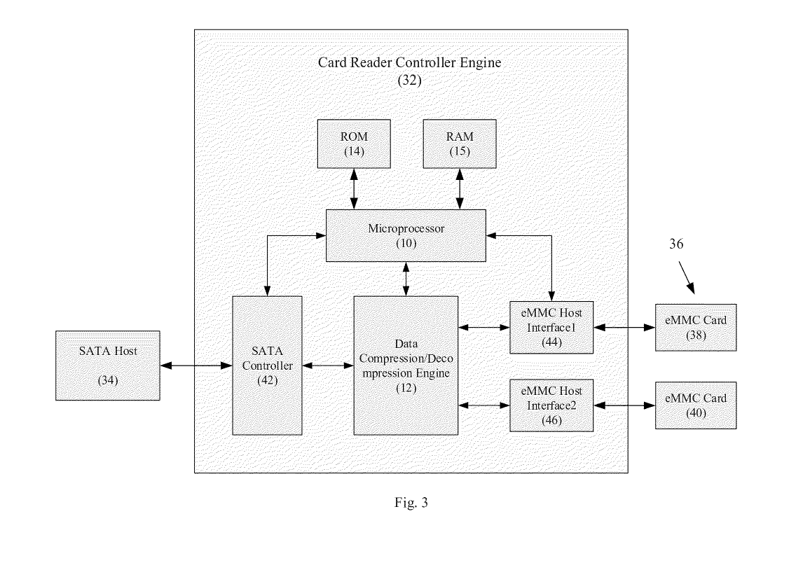

FIG. 3 shows a card reader system 30, in accordance with another embodiment of the invention. The system 30 is shown to include a card reader controller engine 32 coupled to a SATA host 34 and e-Multimedia Card (eMMC) cards 36. In the embodiment of FIG. 3, the eMMC cards 36 is shown to include two eMMC cards, namely eMMC card 38 and eMMC card 40. It is however understood that two eMMC cards is merely being used as an example and that any number of eMMC cards may be employed including a single eMMC card.

The card reader controller engine 32 is analogous to the engine 22 of the embodiment of FIG. 2 except that in place of the USB controller 24, the SATA controller 42 is employed by the engine 32 and in place of the SD host interface 26, one or more eMMC host interfaces 44 and 46 are employed by the engine 32. The number of eMMC host interfaces is generally the same as the number of eMMC cards employed. An example of the SATA controller 42 is a controller that complies with the SATA Standard 2.0 although other versions of the SATA standard are contemplated.

As in the operation of the system 30 of FIG. 3, the engine 32 sends and receives information to and from the SATA host 34 through the SATA controller 42. The SATA host 34 and the SATA controller 42 both comply with the SATA Standard. The controller 42, under the control of the microprocessor 10, sends information to the data compression/decompression engine 12 for compression and/or decompression, as the case may be, and the data compression/decompression engine 12 compresses/decompresses the information and passes the compressed/decompressed information onto the eMMC cards 38 and 40, through the eMMC host interfaces 44 and 46, respectively. Similarly, the engine 12 receives information from the eMMC cards 38 and 40, through the eMMC host interfaces 44 and 46, respectively, under the direction of the microprocessor 10. The received information is then compressed or decompressed, as the case may be, by the data compression/decompression engine 12, which passes the compressed/decompressed information to the SATA host 34 through the SATA controller, under the direction of the microprocessor 10.

In embodiments using two eMMC cards, the data compression/decompression engine 12 compresses/decompresses information intended for or received from one of the eMMC cards, such as the eMMC card 38, through the eMMC host interface 44, and then compresses/decompresses information intended for or received from the other eMMC card, i.e. eMMC card 40.

Referring back to FIG. 2, while not shown therein, it is contemplated that the system 20 of FIG. 2 may employ multiple SD cards, as done in the system 30 of FIG. 3 with multiple eMMC cards. In embodiments where multiple SD cards are employed, multiple SD host interfaces need be employed.

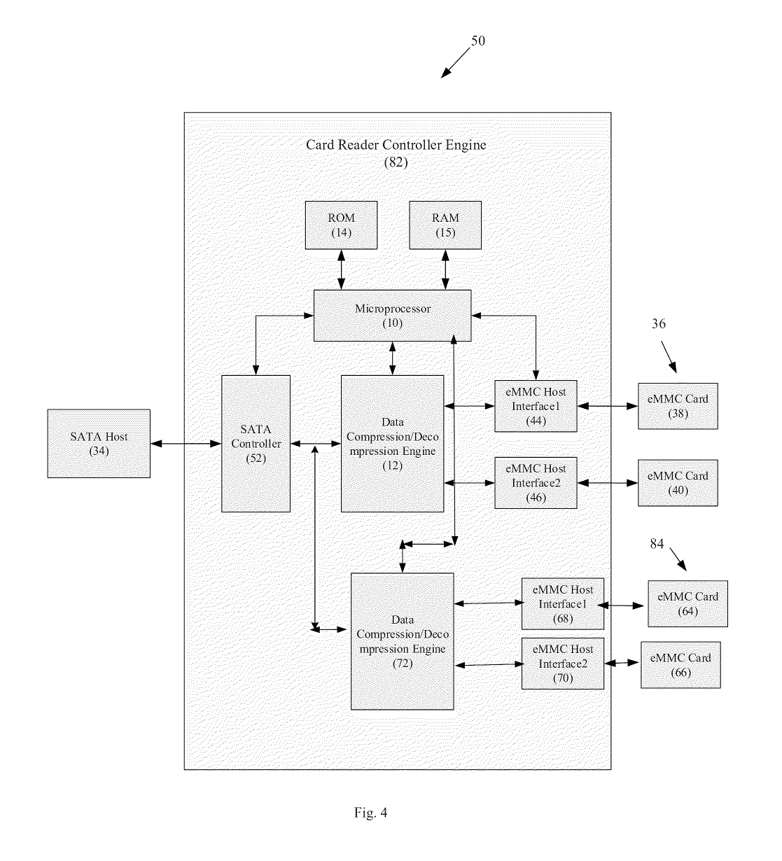

FIG. 4 shows a card reader system 50, in accordance with an embodiment of the invention. The system is analogous to the system 30 of FIG. 3 except that multiple data compression/decompression engines are employed by the system 50 with each data compression/decompression engine coupled to two eMMC host interfaces. For example, while the data compression/decompression engine 12 is shown coupled to the eMMC cards 36, as shown in the embodiment of FIG. 3, a second data compression/decompression engine 72 is shown coupled to two eMMC host interfaces, the eMMC host interface 68 and 70, which are shown coupled to the eMMC cards 84. The eMMC cards 84 is shown to include the eMMC cards 64 and 66. This allows parallel processing by the two data compression/decompression engines. Each of the engines 12 and 72 can perform compression/decompression of information at substantially the same time therefore increasing the performance of the system. This is obviously at the price of having a larger card reader controller engine.

While two eMMC host interfaces are shown coupled to a single data compression/decompression engine, any suitable number of eMMC host interfaces may be coupled to a data compression/decompression engine. Additionally, while two data compression/decompression engines are employed in the system 50, any suitable number of data compression/decompression engines may be employed. Clearly, with the addition of data compression/decompression engines, the performance is increased.

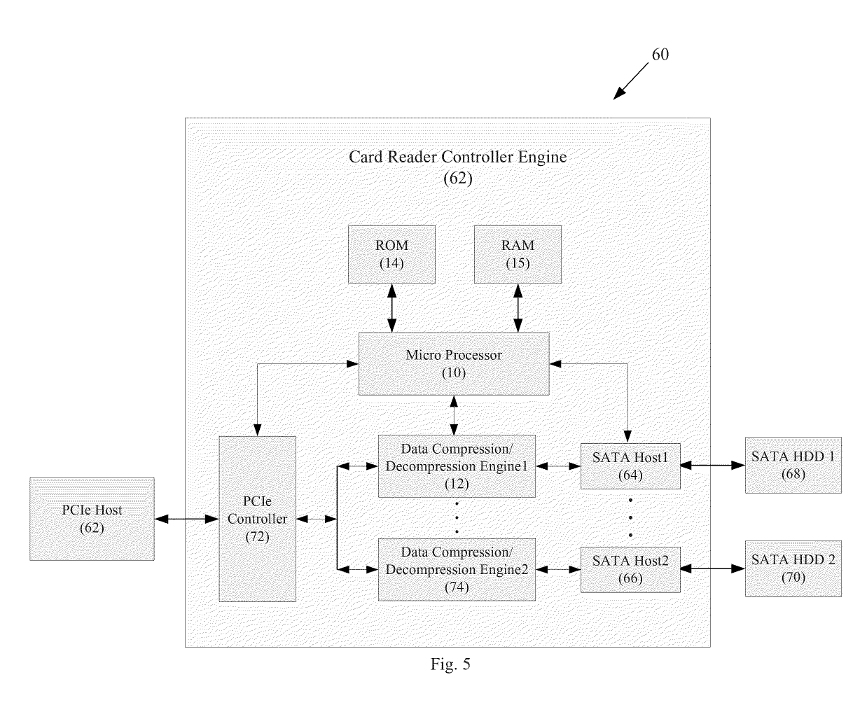

FIG. 5 shows a card reader system, in accordance with still another embodiment of the invention. Card reader system 60 is shown to include a Peripheral Component Interconnect Express (PCIe) host 62 in communication with the card reader controller engine 62, which is in turn shown to be in communication with the SATA hard disk drive (HDD) 68 and the SATA HDD 70.

The system 60 is analogous to the system 50 of FIG. 4 except that the controller 52 of system 50 is replaced with PCIe controller 72 in system 60 and the interfaces 44 and 48 of system 50 are absent. Rather, the microprocessor 10 is shown coupled to the SATA host 64, rather than the eMMC host interfaces of system 50, and the SATA host 64 is further shown coupled to the engine 12 as well as the SATA HDD 68. Additionally, the engine 74 is shown coupled to the SATA host 66 instead of the eMMC host interfaces of system 50. The SATA host 66 is further shown coupled to the SATA HDD 70. While two sets of data compression/decompression engine, SATA host, and SATA SDD are shown in FIG. 5, it is understood that any number of such components may be employed.

The PCIe controller 72 is coupled to the PCIe host 62 through a PCIe bus. Similarly, the microprocessor 10 and the engines 12 and 74 are coupled to the PCIe controller 72 through a data bus.

Typically, the SATA hosts 68 and 70 are a part of a large storage system, such as those employed in data centers.

As in the system 50, each of the engines 12 and 72 can perform compression/decompression of information at substantially the same time therefore increasing the performance of the system. This is obviously at the price of having a larger card reader controller engine.

The functionality of the system 60 is analogous to that of the system 50 except that a different type of host, i.e. PCIe host 62 communicates with the PCIe controller 72. The SATA hosts 64 and 66 serve as hosts to the SATA HDDs 68 and 70 and under the direction of microprocessor 10, receive and send compressed/decompressed data between the engines 12 and 74 and the SATA HDDs 68 and 70. For example, during a write operation, the SATA host 64 receives compressed data from the engine 12 and relays it to the SATA host 68 for storage. During a read operation, decompressed data, stored in the SATA HDD 68, is retrieved by the SATA host 64 and relayed to the engine for decompression. In some embodiments, decompressed data is sent by the engine 12 to the SATA host 64 for storage in the SATA HDD 68.

It is understood that the engine 62 is PCIe-compliant as well as SATA-compliant. “Compliant”, as used herein, refers to adhering with the requirements of that which is being complied to. For example, PCIe-compliant refers to adhering to the requirements of the PCIe Specification, as determined by the industry.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A card reader system comprising:
card reader controller engine in communication with a Peripheral Component Interconnect Express (PCIe) host and one or more Serial Advanced Technology Attachment (SATA) hard disk drives (HDDs), the card reader controller engine including,
a PCIe controller responsive to information from the PCIe host;
an engine coupled to the PCIe controller and configured to compress the information before the information is stored in the one or more SATA HDDs; and
at least one SATA host coupled to the engine and
responsive to the compressed information for storage in and retrieval from the SATA HDDs.

2. The card reader system of claim 1, wherein the reader controller engine further including a microprocessor, the engine, the PCIe controller and the at least one SATA host transmitting or receiving the information under the control of the microprocessor.

3. The card reader system of claim 1, wherein the PCIe controller is in communication with the PCIe host to receive the information.

4. The card reader system of claim 1, wherein the engine is configured to decompress the information.

5. The card reader controller engine of claim 1, wherein the PCIe controller being responsive to another information from the PCIe host and transmitting the same to the engine.

6. The card reader system of claim 5, wherein the engine is configured to compress the another information for transmission through the SATA hosts to the at least one SATA HDD.

7. The card reader system of claim 1, wherein the card reader controller engine is PCIe and SATA compliant.

8. The card reader system of claim 1, wherein the card reader controller engine includes more than one engine.

9. The card reader system of claim 8, wherein the engines relay information to a respective SATA host of the SATA hosts substantially simultaneously.

10. A card reader system comprising:
a Peripheral Component Interconnect Express (PCIe) host;
at least one Serial Advanced Technology Attachment (SATA) HDD;
a card reader controller engine coupled to the PCIe host and the at least one SATA HDDs and including,
the card reader controller engine including,
a PCIe controller responsive to information from the PCIe host;
an engine coupled to the PCIe controller and configured to compress the information before the information is stored in the one or more SATA HDDs; and
at least one SATA host coupled to the engine and responsive to the compressed information for storage in and retrieval from the SATA HDDs.

11. The card reader system of claim 10, wherein the reader controller engine further including a microprocessor, the engine, the PCIe controller and the at least one SATA host transmitting or receiving the information under the control of the microprocessor.

12. The card reader system of claim 10, wherein the PCIe controller is in communication with the PCIe host to receive the information.

13. The card reader system of claim 10, wherein the engine is configured to decompress the information.

14. The card reader controller engine of claim 10, wherein the PCIe controller being responsive to another information from the PCIe host and transmitting the same to the engine.

15. The card reader system of claim 14, wherein the engine is configured to compress the another information for transmission through the SATA hosts to the at least one SATA HDD.

16. The card reader system of claim 10, wherein the card reader controller engine is PCIe and SATA compliant.

17. The card reader system of claim 10, wherein the card reader controller engine includes more than one engine.

18. The card reader system of claim 17, wherein the engines relay information to a respective SATA host of the SATA hosts substantially simultaneously.
